(19) United States
(12) Patent Application Publication
(10) Pub. No.: US 2024/0344873 A1
(43) Pub. Date: Oct. 17, 2024

(54) MULTI-VOLUME MEASURING DEVICE WITH AN INCREMENTAL MEASUREMENT FEATURE

(71) Applicant: Jonathan Edgar Roth, San Mateo, CA (US)

(72) Inventor: Jonathan Edgar Roth, San Mateo, CA (US)

(21) Appl. No.: 18/613,877

(22) Filed: Mar. 22, 2024

Related U.S. Application Data
(60) Provisional application No. 63/453,789, filed on Mar. 22, 2023.

(51) Int. Cl. G01F 19/00

(52) U.S. Cl. CPC G01F 19/002

(57) ABSTRACT

A measuring device for measuring quantities of one or more substances includes a receptacle body for holding the substances and a top edge formed around the receptacle body. The top edge defines a first plane and the receptacle body defines a first volume of the substances when filled to the top edge. A leveling edge is formed along the top edge configured to allow excess substance to be leveled off. An interior measuring ledge protrudes from the receptacle body into the cavity and defines a second plane in conjunction with the leveling edge intersecting the first plane. The interior measuring ledge defines a second volume within the first volume configured for filling with the substances to the interior measuring ledge.

### CROSS-REFERENCE TO RELATED APPLICATIONS

Priority is claimed to U.S. Provisional Application No. 63/453,789 filed Mar. 22, 2023, which is incorporated herein by reference in its entirety.

### FIELD

The present disclosure relates to measuring devices, such as cups, scoops, or spoons, and particularly a measuring spoon configured for measuring multiple volumes.

### BACKGROUND

Measuring devices or vessels that can determine multiple volumes offer convenience and flexibility, particularly for liquids, where marked indicia assist with precise measurements. However, when measuring solid materials, like baking ingredients and the like, these tools can pose a great challenge to precision and accuracy. Sometimes they require complex and time-consuming procedures involving filling, emptying, and leveling to achieve accurate measurements. Often, more than one measuring tool is required.

Some existing solutions, including mechanically adjustable volume devices, attempt to address these challenges but introduce new issues, such as complexity in manufacturing, cleaning difficulties, reduced durability due to moving parts, and limitations in measuring solids due to pouring and leveling difficulties. Despite innovations in liquid measurement, there remains a demand for a practical, multi-volume measuring device without moving parts suitable for both solids and liquids.

### BRIEF SUMMARY

In one aspect, a measuring device for measuring quantities of one or more substances includes a receptacle body for holding the substances, a top edge formed around the receptacle body, the top edge defining a first plane, the receptacle body defining a first volume of the substances when filled to the top edge, a leveling edge formed along the top edge configured to allow excess substance to be leveled off, and an interior measuring ledge protruding from the receptacle body into the cavity and defining a second plane in conjunction with the leveling edge intersecting the first plane, where the interior measuring ledge defines a second volume within the first volume configured for filling with the substances to the interior measuring ledge.

The measuring device may also include a handle extending from the receptacle body for ease of manipulation and pouring of the substances from the receptacle body. The interior measuring ledge should include a flat top surface lying within the second plane configured to allow excess substance to be leveled off when filled with the substance to the interior measuring ledge.

The measuring device may further include a plurality of interior measuring ledges protruding into the receptacle body at unique positions and corresponding to unique volume measurements of different quantities of the substances, where each of the plurality of interior measuring ledges defines a unique corresponding plane in conjunction with the leveling edge intersecting the first plane and where the first plane and the unique corresponding planes are non-parallel. The measuring device may further include an exterior base surface configured to rest upon a flat surface, where the base surface is oriented such that the leveling edge is parallel to the flat surface.

In another example, the measuring device may include a measurement indicator line formed on the receptacle body and corresponding to a plane defined by the leveling edge and an interior measuring ledge. The receptacle body having an exterior body may include radiused corners and edges configured for ease of washing and desirable aesthetic appearance. The measuring device may also include leveling edge spanning a width of the top edge formed around the receptacle body forming a path for leveling and pouring of the substances.

The present disclosure provides for a set of measuring devices having a plurality of receptacle bodies, where each receptacle body defines a different total volume for measuring a quantity of a substance and each receptacle body includes a plurality of interior measuring ledges. The receptacle bodies can be configured to nest within one another such that the interior measuring ledges of adjacent receptacles interdigitate when viewed in cross-section. A leveling tool can be configured to sweep across the leveling edge of each receptacle body.

In another aspect, a measuring device for measuring quantities of one or more substances, includes a receptacle body for receiving a quantity of one or more substances and a top edge formed around the receptacle lying within a first plane, a handle extending from the receptacle body, a leveling edge formed as part of the top edge and located opposite the handle, and a plurality of indicia or markings provided on the body configured as measurement indicators corresponding to different volumes within the receptacle. The plurality of indicia or markings are configured to align the one or more substances along a unique plane that is non-parallel to the first plane when leveled and filled to any of the plurality of indicia or markings. The measuring device may also include where the plurality of indicia or markings include visible tick marks formed on an interior surface of the receptacle body corresponding to measurement indicators of different volumes.

In yet another aspect, a method of measuring a volume of a substance, includes providing a measuring device having a receptacle body, a top edge, a leveling edge formed as part of the top edge, and one or more interior measuring ledges, where each of the one or more ledges and the leveling edge define a plane that intersects the leveling edge at a non-zero angle relative to a plane defined by the top edge, filling the receptacle body with a substance, leveling the substance by removing excess substance by tilting the receptacle body such that the substance is leveled in alignment with one of the internal ledges and the leveling edge. The method may also include the steps of shaking the device to level the substance against the leveling edge and determining a quantity of the substance based on its level relative to one or more of the interior measuring ledges. The method may further include the steps of sweeping a leveling tool across the leveling edge aligned with one of the plurality of interior measuring ledges, and removing excess substance to measure a desired volume of the substance.

The measuring device may also include where each unique corresponding plane is separate and distinct from any other unique corresponding plane and where each unique volume is less than the first volume. The measuring device may also include where the plurality of interior measuring ledges within the receptacle body are arranged in a configuration of at least one interior measuring ledge positioned in front of another interior measuring ledge. The measuring device may also include where at least one interior measuring ledges is positioned adjacent to another interior measuring ledge in a side-by-side configuration. The measuring device may also include further includes indicia or markings configured as measurement indicators corresponding to each unique volume defined by each of the plurality of interior measuring ledges. The measuring device may also include where the indicia or markings include engraved or embossed markings on the body. The measuring device may also include where the first volume is one cup, and the plurality of interior measuring ledges include indicia or markings corresponding to at least one unique volume of ¼ cup, ⅓ cup, ½ cup, ⅔ cup, or ¾ cup.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a perspective view of an example measuring device shown as a measuring spoon according to the present disclosure.

FIG. 1B illustrates the measuring device of FIG. 1A from a different perspective view.

FIG. 1C illustrates a top view of the measuring device of FIG. 1A.

FIG. 1D illustrates a side view of the measuring device of FIG. 1A.

FIG. 1E illustrates a cross-section view of the measuring device from FIG. 1C.

FIG. 2A illustrates a perspective bottom-side view of an example four-level measuring scoop of the present disclosure.

FIG. 2B illustrates a perspective top-side view of the measuring scoop of FIG. 2A.

FIG. 2C illustrates a top view of the measuring device of FIG. 2A.

FIG. 2D illustrates a cross-section view of the measuring device from FIG. 2C.

FIG. 3A illustrates a perspective view of an example six-level measuring scoop of the present disclosure.

FIG. 3B illustrates a side view of the six-level measuring scoop of FIG. 3A.

FIG. 3C illustrates a top view of the measuring device of FIG. 3A.

FIG. 3D illustrates a tilted and resting on a surface side view of the measuring device of FIG. 3A.

FIG. 3E illustrates a cross-section view of the measuring device from FIG. 3C.

FIG. 3F illustrates a back-side handle view of the measuring device of FIG. 3A.

FIG. 3G illustrates a front-side view of the measuring device of FIG. 3A.

FIG. 4A illustrates a perspective view of an example set of measuring cups according to the present disclosure.

FIG. 4B illustrates a top view of the set of measuring cups from FIG. 4A.

FIG. 4C illustrates a cross-section view of the measuring device from FIG. 4B.

FIG. 4D illustrates a top view of the set of measuring cups from FIG. 4A un-nested from each other.

FIG. 4E illustrates a perspective view of the set of measuring cups from FIG. 4A un-nested from each other.

FIG. 5A illustrates a side view of an example leveling tool of the present disclosure.

FIG. 5B illustrates a perspective view of the leveling tool of FIG. 5A.

FIG. 6A illustrates an example measuring system with a measuring scoop according to the present disclosure and the level from FIG. 5A.

FIG. 6B illustrates a top view of the measuring system of FIG. 6A.

FIG. 6C illustrates a cross-section view of the measuring device from FIG. 6B.

FIG. 7A illustrates a perspective view of two different 1-cup volume measuring scoops of the present disclosure.

FIG. 7B illustrates a top view of the two different 1-cup volume measuring scoops of the present disclosure.

FIG. 8 illustrates an example graduated measuring scoop of the present disclosure.

FIG. 9 illustrates a flow chart of a method of use according to the present disclosure.

FIG. 10 illustrates a flow chart of an alternative method of use according to the present disclosure.

### DETAILED DESCRIPTION

The present disclosure is directed to a measuring device configured for measuring a desired amount of substances such as solid and liquid materials with improved accuracy and precision. The measuring device includes a novel improvement to existing measuring spoons and measuring cups, often used in kitchens and the like. This device is structured and configured to be oriented at varying angles, allowing a user to level a surface and determine different volumes efficiently. In contrast to conventional designs, including those often seen in liquid measuring cups that use a spout for decanting, the present disclosure includes a leveling edge. The leveling edge is generally elongated and substantially straight to provide for easy alignment and removal of excess substances. This feature not only facilitates the removal of solid materials, which may require pouring, shaking, or the use of a leveling tool to achieve a substantially flat top surface, but also accommodates liquid measurements.

In an example embodiment, the present disclosure provides for a device that incorporates internal measuring ledges, aligning with specific planes corresponding to internal volume measurement indicators. Substances can be filled to the desired amount or volume corresponding to a measuring ledge and then excess can easily be removed. These ledges, which may feature flat surfaces within the corresponding plane, serve as visible indicators from multiple angles, overcoming limitations in existing designs that require viewing from a level surface plane.

The device's angled leveling is configured to expedite and improve the measurement process, enabling efficient scooping or spooning of substances. Excess material can be easily removed, and the correct volume is readily discernible from various viewpoints, including from above. Additional features, such as indicia associated with the internal ledges and lines formed on an internal surface of the device's body, which correspond to planes including the leveling edge and an internal ledge, enhance volume readability. In an example, a straight edge leveling tool can be employed for precise alignment of the substance surface with the intended measurement level. In certain embodiments, the device allows for nesting of multiple receptacles according to the present disclosure, creating a comprehensive set of differently sized measuring devices that cater to a wide range of volume measurements.

The present disclosure enhances the ease and speed of measuring diverse volumes, offering a practical solution for more immediate, and relatively hassle-free measurements. It can be adaptable to various substances and measurement needs, and represents a substantial improvement over existing measuring cups, scoops, and spoons. Moreover, its design lends itself to convenient storage in containers of dry goods, serving as a readily available scoop or spoon capable of measuring different volumes at the point of use.

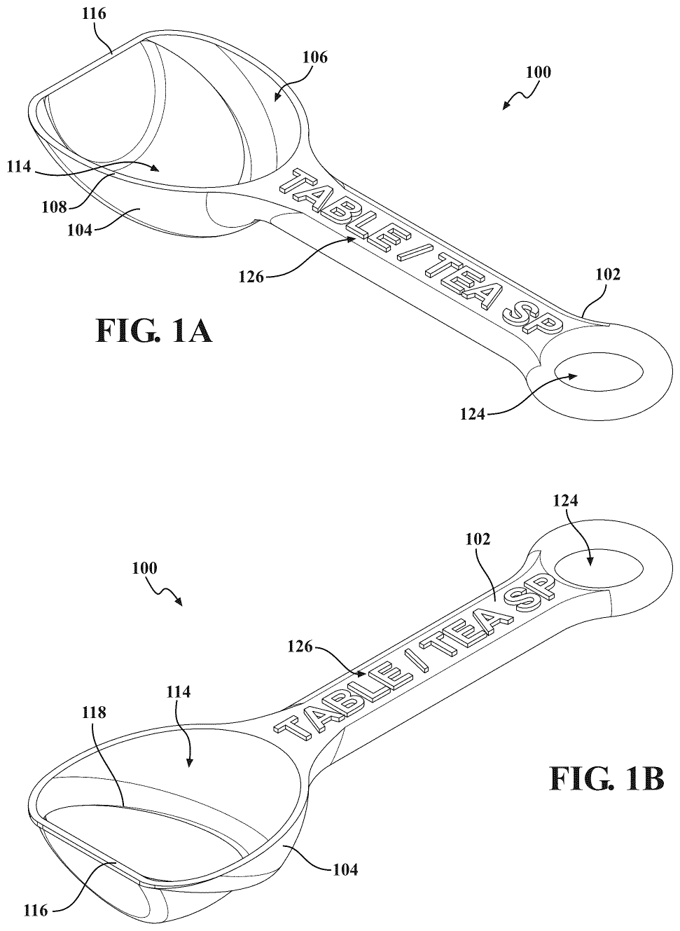

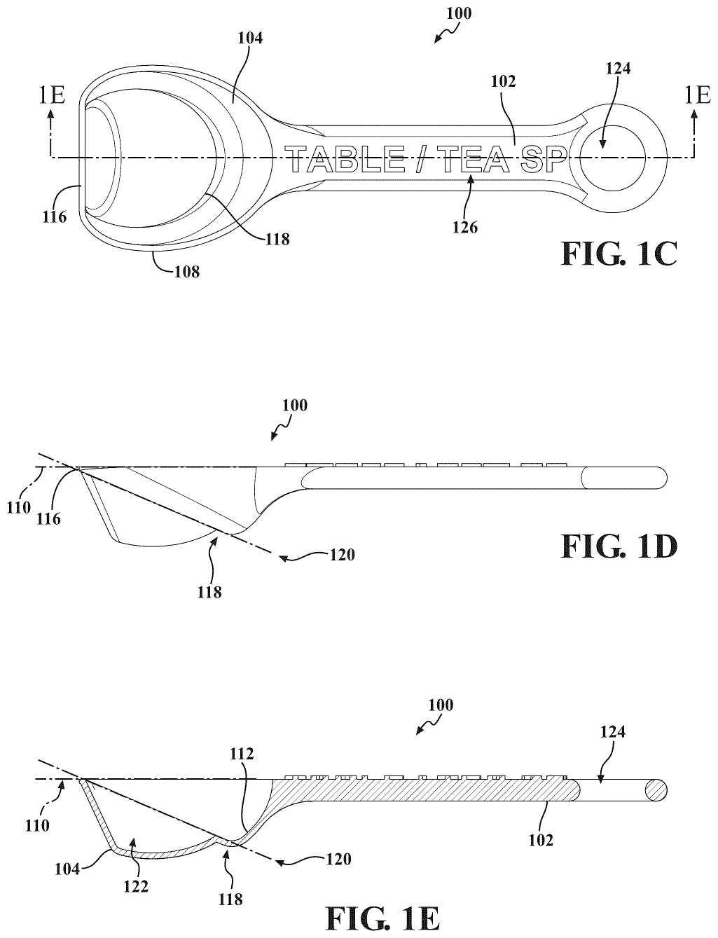

Referring to FIGS. 1A-1E, the present disclosure provides for an example Measuring spoon 100 configured for scooping, measuring, or portioning multiple discrete volumes of materials, including solids and liquids. Measuring spoon 100 includes a handle 102 extending from a receptacle body 104 defining an opening 106. A top edge 108 surrounds the opening 106 and defines a first plane 110 (FIG. 1E). First plane 110 in conjunction with an inner surface of the receptacle body 104 defines an internal volume 114. In this example, internal volume 114 corresponds to a tablespoon.

The top edge 108 includes a leveling edge 116 aligned with an intersection of the first plane 110 and a second plane 120. The second plane 120 is established in conjunction with a measuring ledge 118 intersecting the leveling edge 116. Measuring ledge 118 extends from an inner surface of the receptacle body 104 and thus defines a smaller volume 122 within the internal volume 114. Together, a space confined by the second plane 120 and the inner surface of the receptacle body 104 define the smaller volume 122. In an example, the smaller volume 122 corresponds to a teaspoon. Thus, measuring spoon 100 is configured for easy measurement of either a tablespoon (i.e., internal volume 114) or a teaspoon (i.e., smaller volume 122) by filling a material to the measuring ledge 118 and leveling the material off across the second plane 120.

Leveling edge 116, which is generally elongated and substantially straight, intersects first plane 110 and second plane 120. The measuring ledge 118 is formed along a curved surface 112 on the inner surface of receptacle body 104. Together, measuring ledge 118 and leveling edge 116 define a perimeter, effectively subdividing the internal volume 114 into a smaller volume 122 below second plane 120. The receptacle body 104 can include indication lines on its sides, either the exterior surface or inner surface, which are conspicuously visible on the inside and outside of the receptacle body 104, or both, coincident with the measuring ledge 118 and second plane 120. The indication lines can serve as illustrating to a user that the device (i.e., the measuring spoon 100) is to be leveled at different angles and make it easy to see when the material being measured is leveled to the second plane 120.

In alternative embodiments, measuring ledge 118 may take different forms within the receptacle body 104, as long as it effectively combines with the substantially straight leveling edge 116 to establish a distinct second plane 120. This may include variations such as a straight edge or a flat surface.

To measure the internal volume 114, measuring spoon 100 is held in a flat configuration, aligning first plane 110 parallel to the ground. For solid materials, shaking off excess or using a flat leveling tool (discussed below) to achieve an even surface can be done.

To measure the smaller volume 122, the measuring spoon can be angled so that the second plane 120 is parallel to the ground. For solid or viscous liquids, the substantially straight leveling edge 116 facilitates easy pouring and leveling. Compared to a curved perimeter, the leveling edge 116 being straight and elongated covers a wider region of a material's surface thus reducing resistance to pouring or shaking out excess material and improving accuracy in leveling.

In another example, measuring spoon 100 may include a hole 124 which can be configured for ease of storage like hanging or placing on a loop. Measuring spoon 100 may further include a label 126 to indicate measuring capacity. In FIG. 1C, handle 102 includes a label 126 that reads “TABLE/TEA SP”, indicating the volumes for which the measuring spoon 100 is designed.

Measuring spoon 100 can also be configured for both aesthetic appeal and practicality. The receptacle body 104 can include radiused corners and edges, for example at the endpoints of the substantially straight leveling edge 116 and the adjacent curved surface 112, which not only enhance its visual appearance but also facilitate ease of cleaning by eliminating deep corners in the receptacle body 104 that are hard to access.

In the examples shown in FIGS. 1A-1E, leveling edge 116 is strategically located opposite the handle 102 to provide symmetry in the design for ambidextrous use, and to facilitate pouring excess material forward out a front area of the measuring spoon 100 in the process of leveling, for example, back into a container from which the material may have been scooped. In other embodiments the leveling edge 116 may be found in other orientations relative to the handle.

It should be understood that the present examples are provided to facilitate understanding of the present disclosure and is not intended to limit the scope of the exact features set forth herein. The measuring spoon 100 can be designed to measure volumes other than a teaspoon and a tablespoon. Similar principles can be applied to other measurement receptacles such as scoops and measuring cups. Example materials for manufacture include plastic, composites, injection-molded plastic, glass and metal and metal alloys.

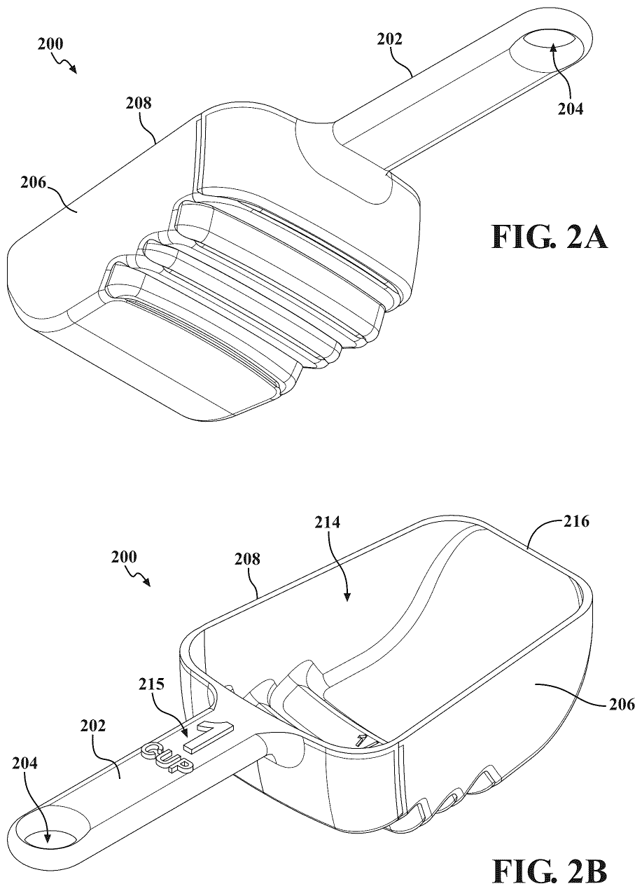

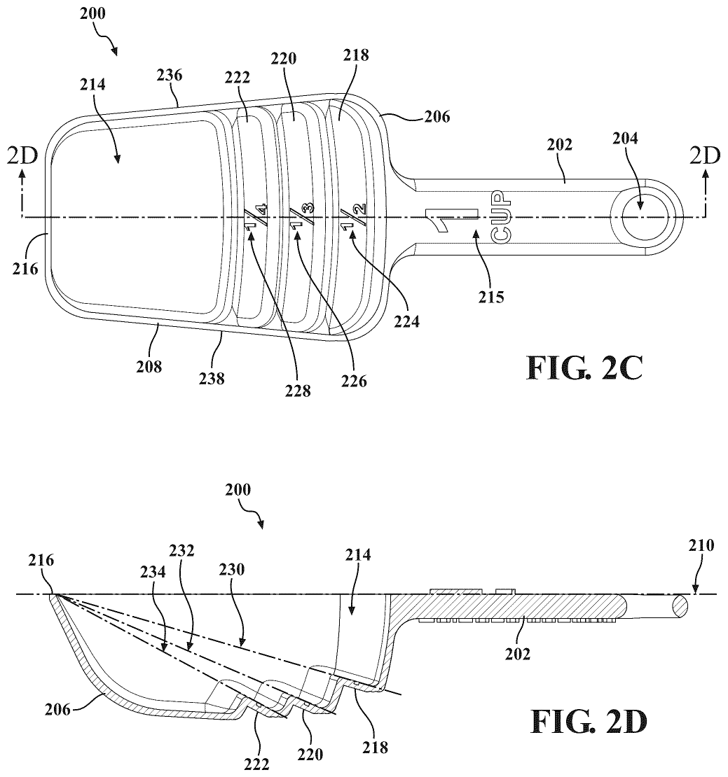

Referring to FIGS. 2A-2D, the present disclosure provides for a measuring scoop 200 configured for scooping, measuring, or portioning multiple discrete volumes of materials, including solids and liquids. In this example, measuring scoop 200 is a four-level measuring scoop having a plurality of measuring ledges 218, 220, and 222.

The measuring scoop 200 shares many features in common with measuring spoon 100. These structural elements include a handle 202 having a hole 204. Handle 202 extends from a receptacle body 206 defining a first volume 214 and having a top edge 208 which includes a substantially straight leveling edge 216. Top edge 208 and leveling edge 216 lie in a first plane 210 as shown in FIG. 2D.

The first volume 214 in this example is equal to one-cup, as indicated by total volume label 215 provided on handle 202. In this example, three measuring ledges (first measuring ledge 218, second measuring ledge 220, and third measuring ledge 222) extend from an inner surface of receptacle body 206. Each measuring ledge (218, 220, 222) include a flat surface spanning a width of the receptacle body 206 from a first side 236 to a second side 238. Together with leveling edge 216, these measuring ledges (218, 220, 222) define three distinct planes (second plane 230, third plane 232, and fourth plane 234, respectively). These planes subdivide the first volume 214 into smaller volumes, measuring one half (½) cup, one third (⅓) cup, and one quarter (¼) cup, respectively. Indicia are provided on flat regions of the measuring ledges 218, 220, 222, indicating the corresponding volumes as shown by ½ volume label 224, ⅓ volume label 226, and ¼ volume label 228.

When emptying excess material, the four-level measuring scoop 200 can be held with the handle 202 tilted at different angles, keeping the substantially straight leveling edge parallel to the ground to match the plane corresponding to the desired volume. As the leveling edge 216 extends from first side 236 to the second side 238 of receptacle body 206, a straight and unobstructed path is formed for efficient leveling and pouring of any contents. The corners where the leveling edge 216 intersect the sides 236 and 238 can be radiused for appearance and to facilitate ease of cleaning by avoiding deep grooves.

In an example, measuring scoop 200 can be used to scoop solid material directly from a container, and excess material can be easily poured or shaken out back into the same container or elsewhere. The measuring ledges (218, 220, and 222) feature flat surfaces that span the width of the receptacle body 206. During the process of emptying excess material from measuring scoop 200, the flat ledge surface becomes fully visible, providing a clear visual indicator of the filled volume. This indicator can be visible from a wide range of vantage points.

In contrast to measuring spoon 100, an internal volume 114 shown as one-tablespoon, the one-cup volume of first volume 214 of measuring scoop 200 includes a plurality of measuring ledges (218, 220, 222), and provides sufficient space to apply indicia (224, 226, 228) directly to the surface of the ledges to indicate corresponding volume, providing improved clarity in volume measurement.

The versatility of the four-level measuring scoop 200 extends beyond its utility in the kitchen. With a one-cup volume, a size commonly used in food storage containers both at home and in grocery self-service bulk foods, it is adaptable to various settings. The design allows for convenient storage in food bins, pantries, or pet food bags, ensuring quick access. This dual-purpose functionality not only facilitates scooping and transferring between containers but also provides precise measurements, enhancing its value in diverse applications. The indicated volumes, such as one cup, one-half cup, or others, are not intended to be limiting, as the design can readily accommodate different capacities, from a 2-cup scoop to a half-cup scoop and beyond and can accommodate different numbers of measuring ledges in addition to those shown. The adaptability of these embodiments, including spoons, extends to storage in a wide range of containers, such as food containers and powdered substance containers, further enhancing versatility and practicality.

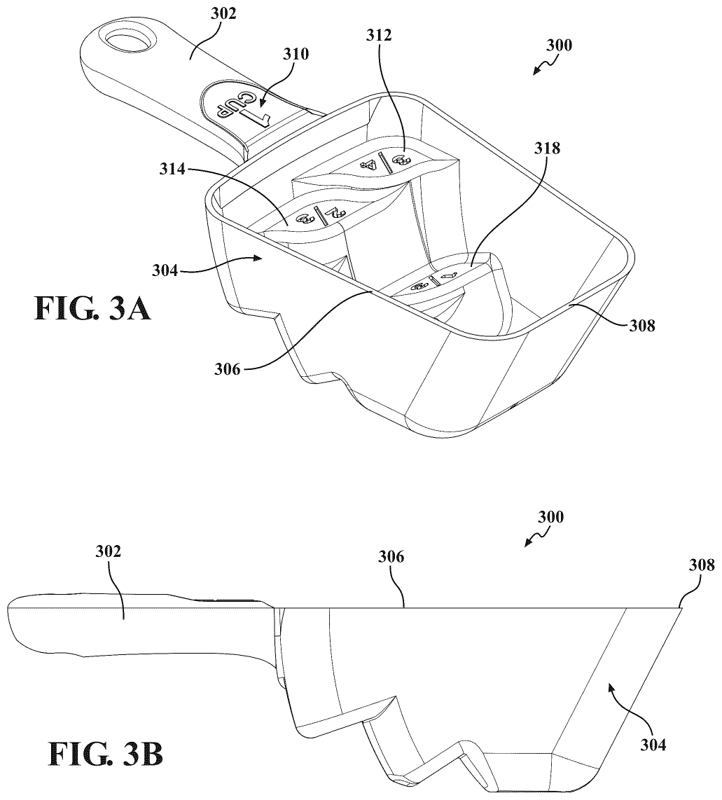

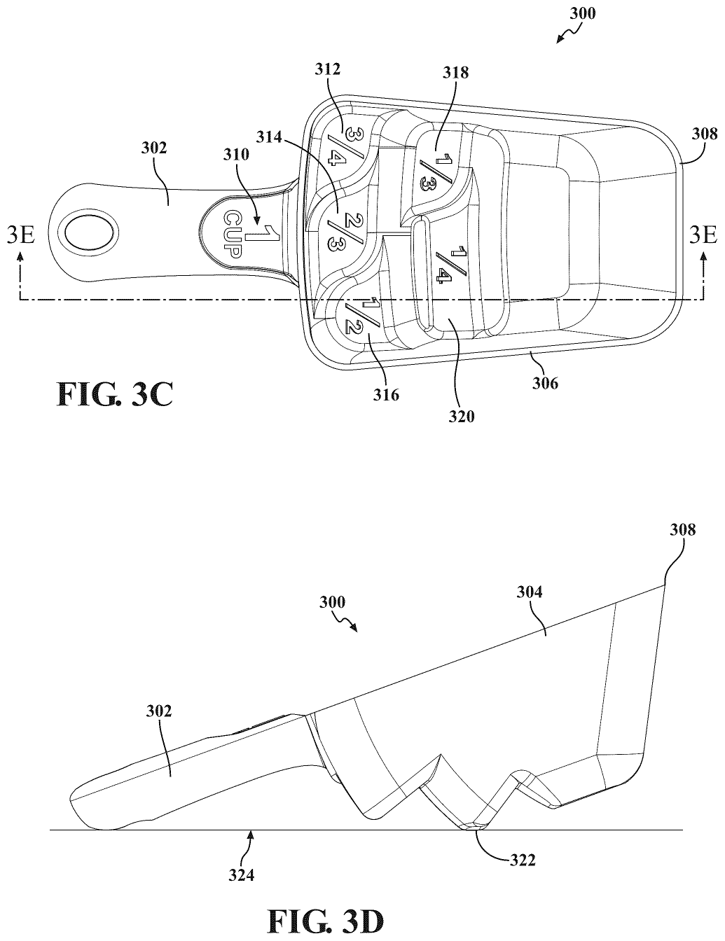

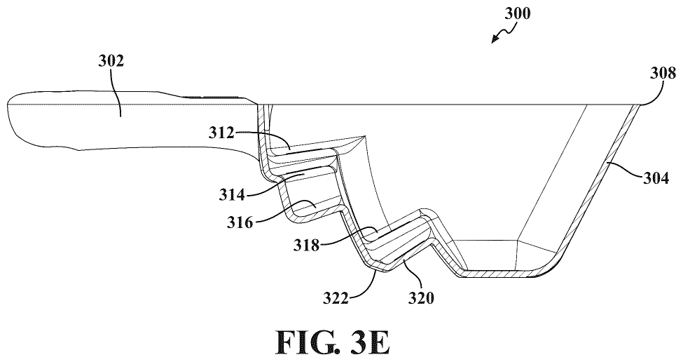

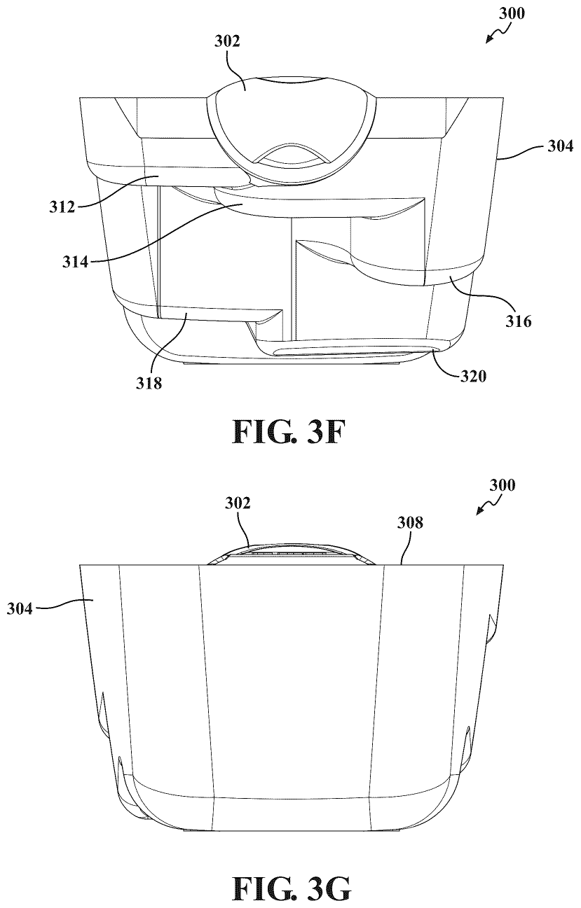

Referring to FIGS. 3A-3G, the present disclosure further provides for a six-level measuring scoop 300 configured for scooping, measuring, or portioning multiple discrete volumes of materials, including solids and liquids. The six-level measuring scoop 300 builds upon the features of the four-level measuring scoop 200 described hereinabove. Similarly, six-level measuring scoop 300 features handle 302, receptacle body 304, and a substantially straight leveling edge 308 as a part of its top edge 306.

In this example, six-level measuring scoop 300 defines a total volume of one cup as evidenced by total volume label 310. Extending from an inner surface of receptacle body 304 are a plurality of measuring ledges (312, 314, 316, 318, and 320) corresponding to volumes of ¾-cup, ⅔-cup, ½-cup, ⅓-cup, and ¼-cup, respectively. The measuring ledges (312, 314, 316, 318, and 320) have flat surfaces upon which measurement indicators (i.e., indicia) are provided corresponding to distinct volumes. Some measuring ledges (e.g., 312, 314, and 316) are positioned side-by-side when viewed from the perspective of the leveling edge 308. Others are arranged in front of one another, as seen with ⅓ cup measuring ledge 318 positioned in front of ¾ cup measuring ledge 312. This results in a more balanced aspect ratio (length vs. width) for the measuring ledges. This allows for larger indicia and easy distinction.

The widths of ⅓ cup measuring ledge 318 and ¼ cup measuring ledge 320 can be formed intentionally unequal to achieve a specific design outcome. In an example, ¼ cup measuring ledge 320 extends across a centerline of six-level measuring scoop 300, resulting in a region of contact of outer surface 322 on an outer surface of receptacle body 304. Region of contact of outer surface 322 aligns with the centerline and functions as a base surface to make contact with a flat surface 324 when the scoop is placed down, as shown in FIG. 3D. This configuration ensures that six-level measuring scoop 300 maintains a balanced appearance while resting on a surface, even when filled with material, preventing or limiting potential spills to the side. This concern becomes particularly relevant when the measuring ledges (312, 314, 316, 318, and 320) are positioned side-by-side. It is especially useful when considering scoop manufacturing methods like injection molding with plastic or metal, where thin walls are common, or when aiming to minimize material usage. Consequently, the bottom contact region of the scoop mirrors the shape of the inner region, addressing both practical and aesthetic considerations.

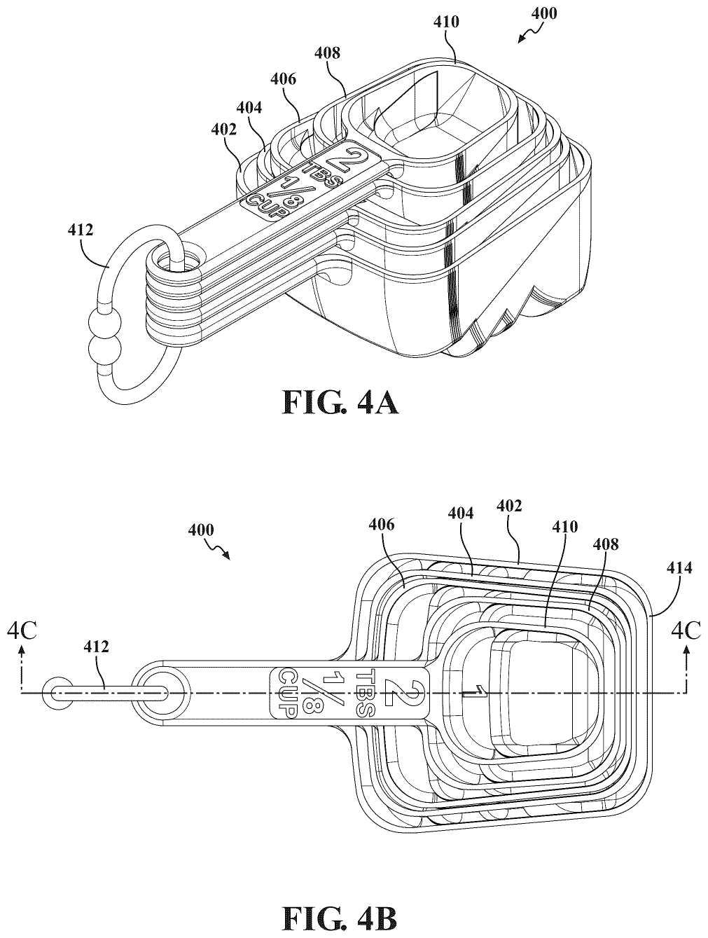

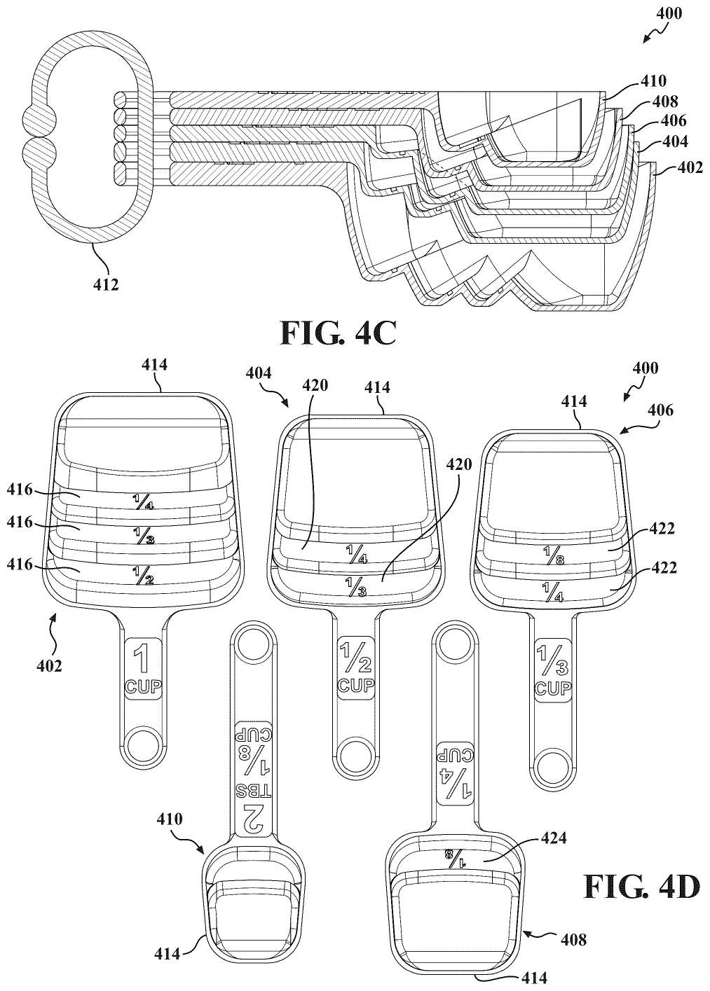

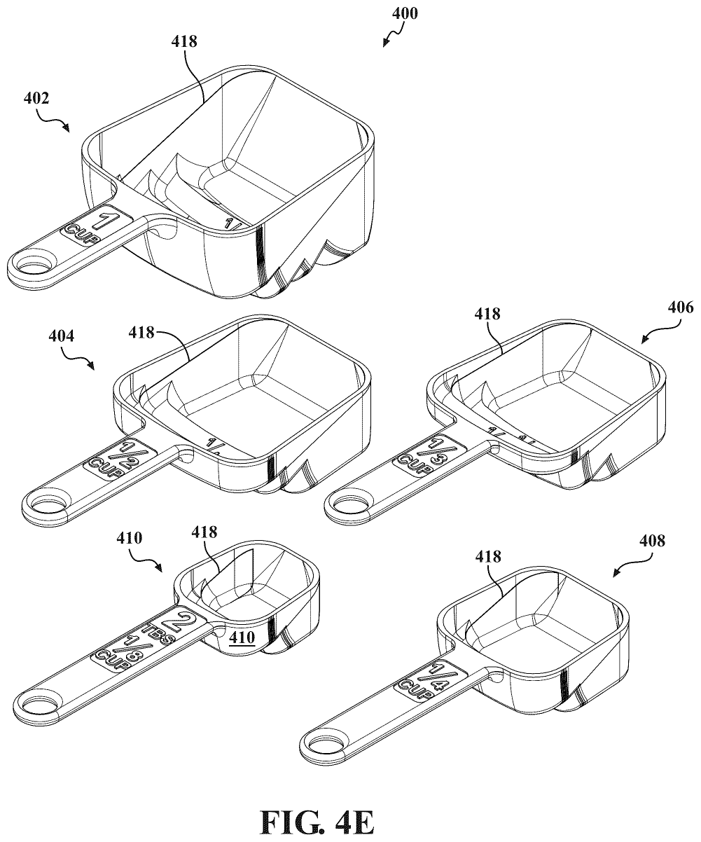

Referring to FIGS. 4A-4E, the present disclosure provides for a measuring cup set 400 having a plurality of independent nesting measuring cups. In this example, measuring cup set 400 includes five measuring cups: a one-cup measuring cup 402, a half-cup measuring cup 404, a third-cup measuring cup 406, a quarter-cup measuring cup 408, and an eighth-cup measuring cup 410. Each of measuring cup (402, 404, 406, 408, 410) in measuring cup set 400 is configured with at least one measuring ledge and as many as three measuring ledges. The measuring cups (402, 404, 406, 408, 410) can be configured to nest within each other for ease in storage and optionally held together via a loop 412.

Each cup (402, 404, 406, 408, 410) in the set shares features in common with previous measuring device examples (See FIGS. 1A-3G) including a receptacle body defining a total volume and a handle with an optional hole. Similar to the four-level measuring scoop 200, the one-cup measuring cup 402 includes a substantially straight leveling edge 414 opposite a handle, and a plurality of measuring ledges 416. In this example, measuring ledges 416 span the width of the receptacle body of one-cup measuring cup 402. This allows for measuring multiple volumes of a substance. Each nesting cup 404, 406, 408, and 410 can each define one or more measuring ledges to achieve a similar outcome (i.e., to measure unique and distinct volumes of material). Similar to the measuring spoon 100, the receptacle bodies of measuring cups 402, 404, 406, 408, and 410 further include one or more measuring lines 418 provided on their sides, which can be visible on an inside surface, an outside surface, or both of the receptacle body, which is an indicator to the user that the material within the cup should be leveled at different angles.

The cross-sectional view of FIG. 4C illustrates the nested cups, showing how the measuring cup set 400 fit together. In order to maintain a compact overall volume of the nested measuring cup set 400, the measuring ledges (one-cup measuring ledges 416, half-cup measuring ledges 420, third-cup measuring ledges 422, and quarter-cup measuring ledge 424) of adjacent receptacles in the measuring cup set 400 are configured to interdigitate and nest within the larger measuring cup, respectively. Due to the interdigitation, the overall volume of the nested measuring cup set 400 is comparable to traditional measuring cup sets that use simpler cylindrical shapes for their receptacle body and do not include a straight leveling edge.

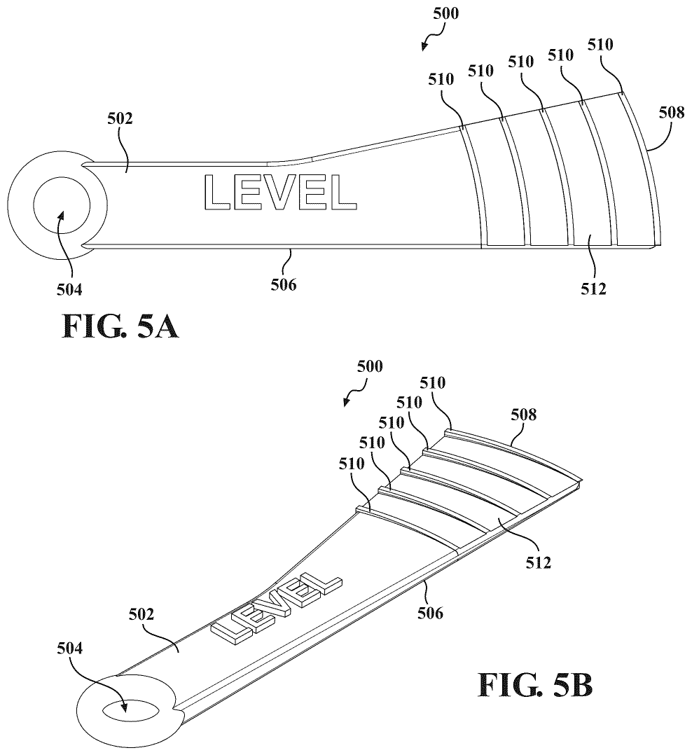

Referring to FIGS. 5A-5B, an example level tool 500 is provided. Level tool 500 includes a handle 502 having a hole 504. In this example, the hole 504 is formed to be suitable for storage with the measuring cup set 400 from FIGS. 4A-E using loop 412. Level tool 500 includes a straight edge 506 extending along the handle 502 and terminating at a contoured edge 508. Ridges 510 extend out from a side face 512 and taper to a reduced thickness at straight edge 506.

Level tool 500 can function as a standard level tool for use with measuring cups. For example, filling a cup with a substance, then scraping the straight edge 506 across an opening to planarize the surface of the substance.

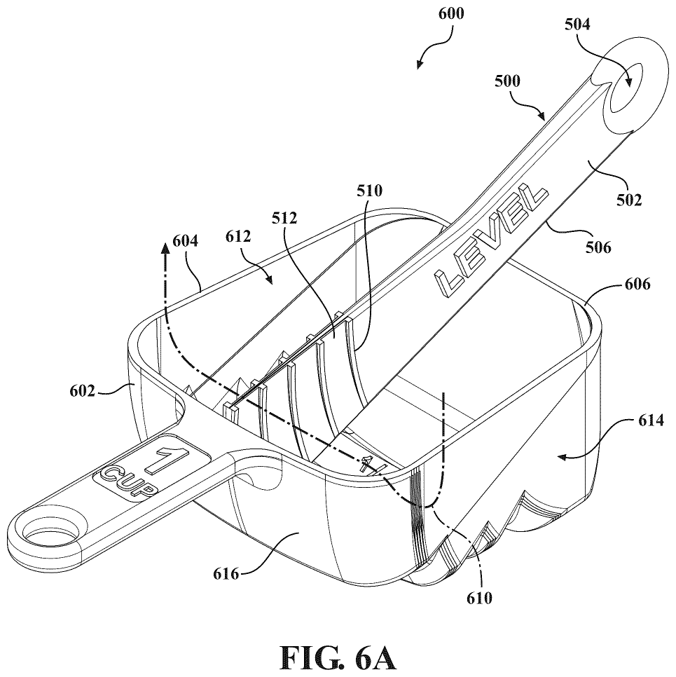

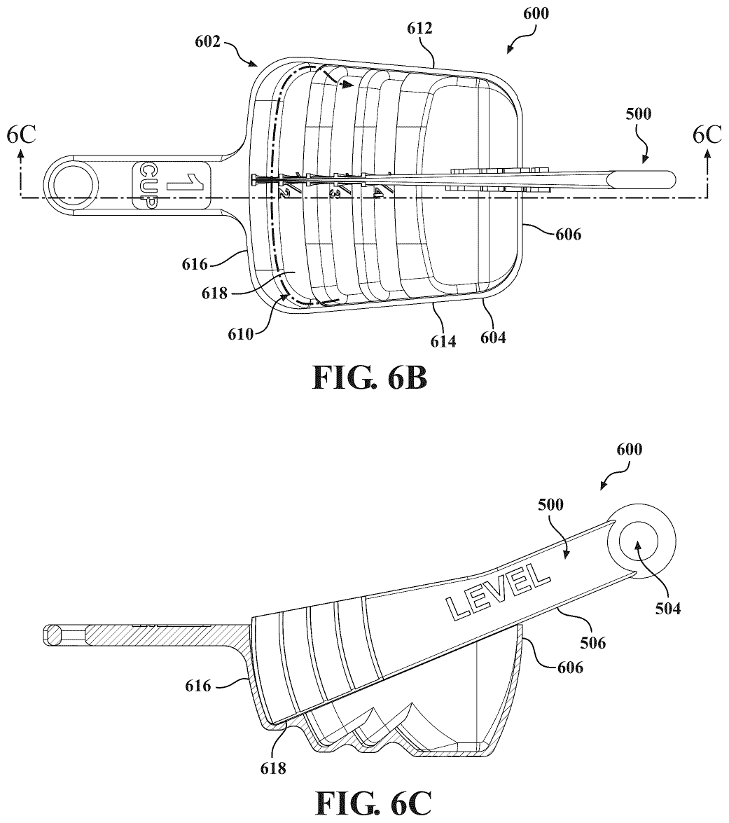

Referring to FIGS. 6A-6C, a one-cup measuring system 600 is provided. The level tool 500 is shown in combination and configured to fit and function with a one-cup receptacle body 602. Level tool 500 can function as a standard level tool that is used with measuring cups, filling a cup with a substance, then scraping the straight edge 506 across the opening to planarize the surface of the substance. The level tool 500 can assist to measure multiple volumes. Receptacle body 602 includes a top edge 604 and a leveling edge 606. The receptacle body 602 is shown in contact with level tool 500, such that level tool 500 abuts along a leveling edge 606 and a back wall 616 of receptacle body 602, such that it can sweep out excess material as it is swept along a path 610. In this example, the path 610 starts with insertion of the level tool 500 at a first side 614 of the receptacle body 602, then sliding across to a second side 612 while maintaining contact with back wall 616, ledge 618, and the substantially straight leveling edge 606, and finally exiting at the second side 612. The volume of the material remaining in the receptacle body 602 levels and aligns with the measuring ledge 618.

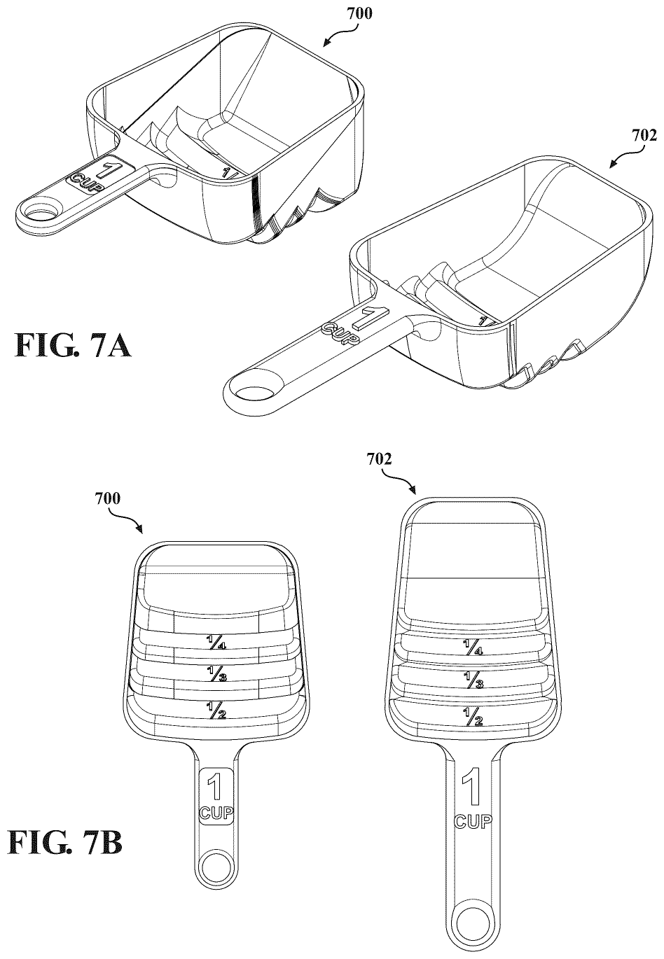

FIGS. 7A-7B illustrate a comparison of size and aspect ratio differences between two example measuring scoops 700 and 702, each with a volume of one cup. Measuring scoop 700 and elongated measuring scoop 702 are both four level measuring scoops. Elongated measuring scoop 702 is longer in the direction of the handle and narrower in width to facilitate inserting a front end in a container, scooping out material, and pouring out excess from the front as compared to measuring scoop 700. Measuring scoop 700 includes a receptacle body that is shorter and wider as compared to elongated measuring scoop 702 and defines a geometry closer to a square aspect ratio from a top side view. This size is more conducive to nesting several measuring cups inside one another. Additionally, since the distance from the substantially straight leveling edge to the back wall is shorter, it is more conducive to leveling with a level tool.

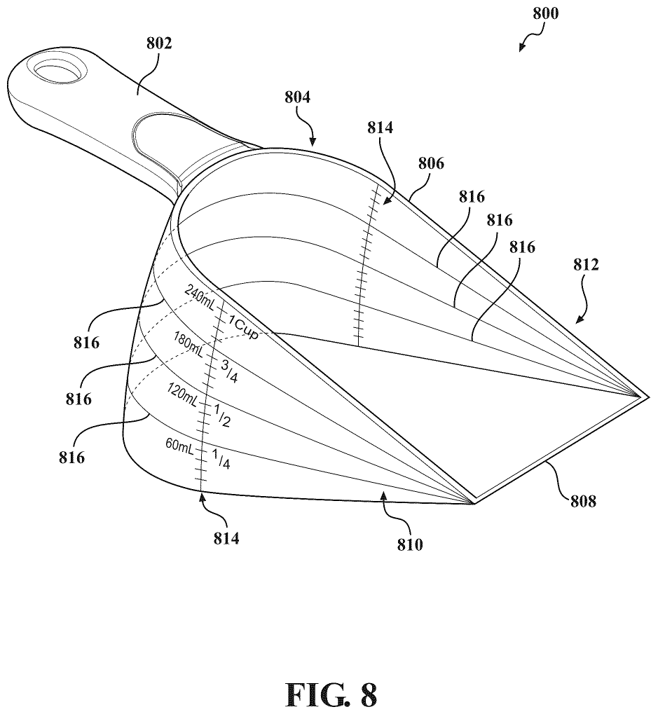

FIG. 8 is a schematic for a top isometric view of a graduated measuring scoop 800. Similar to other embodiments, graduated measuring scoop 800 includes a handle 802, a scoop body 804, a flat opening edge 806 and a substantially straight leveling edge 808. Leveling edge 808 spans most of the distance from first side 810 to the opposite second side 812. Indicia can be formed as graduated markings 814. In this example, graduated markings 814 include tick marks and labels indicating volumes in cups, fractions of a cup, and/or milliliters. Interior lines 816 can be formed on the sides 810, 812) that correspond to desired fractions of one-cup volume, and further extend continuously connecting from one side to the other, and each define a plane in combination with the substantially straight leveling edge 606 that is skew to a plane defined by the flat opening flat opening edge 806 and intersects it at the substantially straight leveling edge 808.

Measuring scoop 800 is configured to be leveled at an angle and can be used to level a solid substance being measured by scooping, tilting at an angle, and shaking flat. The substantially straight leveling edge 808 can span most of the width of the 806 to reduce resistance to emptying solids. The use of a graduated scale allows for the measurement of many different volumes with one device. Other embodiments may combine the features of the measuring scoop with those of other embodiments such as one or more measuring ledges.

Referring to FIG. 9, the present disclosure provides for a method of measuring different volumes of substances 900 using a multi-volume measuring device (i.e., a spoon, cup, or scoop) as described hereinabove. The method provides for improved accurate and convenient ways of measuring different volumes of substances, including both solids and liquids, by employing the unique features of the present disclosure, such as its substantially straight leveling edge, internal ledges, and optional leveling tool.

The method of measuring different volumes of substances 900 includes the steps of:
Step 902: Providing a measuring device with a substantially straight leveling edge and one or more interior measuring ledges, where each ledge and the leveling edge define a plane that intersects the leveling edge at an angle relative to a plane defined by the top edge of the device;
Step 904: Filling the measuring device with a substance to be measured; and
Step 906: Tilting the measuring device to level the substance against the leveling edge such that the substance is leveled in alignment with one of the measuring ledges, thus defining a specific volume of the substance.

Method 900 can further include the following optional steps:
Optional Step 908: Shaking the device to further level the substance against the leveling edge; and
Optional Step 910: Determining the volume of the substance based on its level relative to one or more of the interior measuring ledges.

Referring to FIG. 10, a flow diagram of an alternative extension of the method for measuring a volume of a substance as described in FIG. 9 is shown and designated as process 1000. Process 1000 includes the initial steps of method 900 (Steps 1002, 1004, and 1006, mirroring steps 902, 904, and 906, respectively) and introduces the following additional steps:
Optional Step 1008: Sweeping a leveling tool across the leveling edge of the device, ensuring it contacts one of the interior measuring ledges; and
Optional Step 1010: Removing excess substance using the leveling tool to achieve the desired volume. Carrying out these steps with the level ensures precise and accurate measurements.

The methods of use described offer a novel approach to measuring substances, utilizing the unique design of the multi-volume measuring devices described hereinabove. These methods are advantageous for both household and professional use, providing ease of operation, precision in measurement, and versatility in application. The optional steps offer additional flexibility, allowing users to choose the most suitable technique for their specific needs, whether it involves shaking the device or using a leveling tool for more precision.

It should be noted that while the method steps are described in a specific order, they can be performed in a different sequence or in parallel, depending on the user's preference and the nature of the substance being measured. Additionally, some steps can be omitted in various embodiments, providing further adaptability to the user's requirements.

It should be noted that the steps described in the method of use can be conducted in many different orders according to user preference. The use of “step of” should not be interpreted as “step for”, in the claims herein and is not intended to invoke the provisions of 35 U.S.C. § 112(f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A measuring device for measuring quantities of one or more substances comprising:
a receptacle body for holding the substances;
a top edge formed around the receptacle body, the top edge defining a first plane, the receptacle body defining a first volume of the substances when filled to the top edge;
a leveling edge formed along the top edge configured to allow excess substance to be leveled off; and
an interior measuring ledge protruding from the receptacle body into the cavity and defining a second plane in conjunction with the leveling edge intersecting the first plane;
wherein the interior measuring ledge defines a second volume within the first volume configured for filling with the substances to the interior measuring ledge.

2. The measuring device of claim 1, further comprising a handle extending from the receptacle body for ease of manipulation and pouring of the substances from the receptacle body.

3. The measuring device of claim 1, wherein the interior measuring ledge includes a flat top surface lying within the second plane configured to allow excess substance to be leveled off when filled with the substance to the interior measuring ledge.

4. The measuring device of claim 1, further comprising a plurality of interior measuring ledges protruding into the receptacle body at unique positions and corresponding to unique volume measurements of different quantities of the substances, wherein each of the plurality of interior measuring ledges defines a unique corresponding plane in conjunction with the leveling edge intersecting the first plane and wherein the first plane and the unique corresponding planes are non-parallel.

5. The measuring device of claim 4, wherein each unique corresponding plane is separate and distinct from any other unique corresponding plane and wherein each unique volume is less than the first volume.

6. The measuring device of claim 4, wherein the plurality of interior measuring ledges within the receptacle body are arranged in a configuration of at least one interior measuring ledge positioned in front of another interior measuring ledge.

7. The measuring device of claim 6, wherein at least one interior measuring ledge is positioned adjacent to another interior measuring ledge in a side-by-side configuration.

8. The measuring device of claim 4, further comprising indicia or markings configured as measurement indicators corresponding to each unique volume defined by each of the plurality of interior measuring ledges.

9. The measuring device of claim 8, wherein the indicia or markings include engraved or embossed markings on the body.

10. The measuring device of claim 4, wherein the first volume is one cup, and the plurality of interior measuring ledges include indicia or markings corresponding to at least one unique volume of ¼ cup, ⅓ cup, ½ cup, ⅔ cup, or ¾ cup.

11. The measuring device of claim 1, further comprising an exterior base surface configured to rest upon a flat surface, wherein the base surface is oriented such that the leveling edge is parallel to the flat surface.

12. The measuring device of claim 1, further comprising a measurement indicator line formed on the body and corresponding to a plane defined by the leveling edge and an interior measuring ledge.

13. The measuring device of claim 1, wherein the body includes an exterior body having radiused corners and edges configured for ease of washing and desirable aesthetic appearance.

14. The measuring device of claim 1, wherein the leveling edge spans a width of the top edge formed around the receptacle body forming a path for leveling and pouring of the substances.

15. A measuring device for measuring quantities of one or more substances, comprising:
a receptacle body for receiving a quantity of one or more substances and a top edge formed around the receptacle body lying within a first plane;
a handle extending from the body;
a leveling edge formed as part of the top edge and located opposite the handle; and
a plurality of indicia or markings provided on the body configured as measurement indicators corresponding to different volumes within the receptacle body;
wherein the plurality of indicia or markings are configured to align the one or more substances along a unique plane that is non-parallel to the first plane when leveled and filled to any of the plurality of indicia or markings.

16. The measuring device of claim 15, wherein the plurality of indicia or markings comprise visible tick marks formed on an interior surface of the receptacle body corresponding to measurement indicators of different volumes.

17. A method of measuring a volume of a substance, comprising:
providing a measuring device having a receptacle body, a top edge, a leveling edge formed as part of the top edge, and one or more interior measuring ledges, wherein each of the one or more ledges and the leveling edge define a plane that intersects the leveling edge at a non-zero angle relative to a plane defined by the top edge;
filling the receptacle body with a substance; and
leveling the substance by removing excess substance by tilting the receptacle body such that the substance is leveled in alignment with one of the internal ledges and the leveling edge.

18. The method of claim 17, further comprising the steps of shaking the device to level the substance against the leveling edge and determining a quantity of the substance based on its level relative to one or more of the interior measuring ledges.

19. The method of claim 17, further comprising the steps of sweeping a leveling tool across the leveling edge aligned with one of the plurality of interior measuring ledges, and removing excess substance to measure a desired volume of the substance.

20. A set of measuring devices comprising:
a plurality of receptacle bodies according to claim 1, wherein each receptacle body defines a different total volume for measuring a quantity of a substance and each receptacle body includes a plurality of interior measuring ledges, the receptacle bodies being configured to nest within one another such that the interior measuring ledges of adjacent receptacle bodies interdigitate when viewed in cross-section, and
a leveling tool configured to sweep across the leveling edge of each receptacle.
